(19) United States
(12) Patent Application Publication
(10) Pub. No.: US 2021/0031095 A1
(43) Pub. Date: Feb. 4, 2021

(54) PROGRAM, ELECTRONIC DEVICE, METHOD, AND SYSTEM

(71) Applicant: CYGAMES, INC., Tokyo (JP)

(72) Inventors: Yuki Ono, Tokyo (JP); Tomonosuke Masuyama, Tokyo (JP)

(73) Assignee: CYGAMES, INC., Tokyo (JP)

(21) Appl. No.: 17/073,905

(22) Filed: Oct. 19, 2020

Related U.S. Application Data
(63) Continuation of application No. PCT/JP2019/016769, filed on Apr. 19, 2019.

(30) Foreign Application Priority Data
Apr. 20, 2018 (JP) 2018-081453

(51) Int. Cl. A63F 7/02; A63F 13/2145; A63F 13/812; A63F 13/92

(52) U.S. Cl. CPC A63F 7/027; A63F 13/92; A63F 13/812; A63F 13/2145

(57) ABSTRACT

One or more embodiments of the invention is a program for a game executed on an electronic device that accepts player inputs, the program causing the electronic device to execute: a screen display step of displaying a game screen including a player object that moves in a game field in which a virtual gravity is set, as well as collidable objects and an operated object that are disposed in the game field; an object control step of causing the operated object to be manipulated on the basis of a player input accepted by the electronic device; and a player-object control step of giving a movement velocity to the player object in a direction toward a target object, which is one of the collidable objects, on the basis of the player input accepted by the electronic device in the case where a predetermined condition is satisfied.

### TECHNICAL FIELD

The present invention relates to programs, etc. In particular, the present invention relates to a program, etc. for a game executed on an electronic device that accepts player inputs.

### BACKGROUND ART

The recent popularization of compact portable electronic devices, such as smartphones, has rapidly advanced, and a large number of games that are executed on such portable electronic devices have been released. A pinball game is known as an example of games of this kind, in which points are gained by operating a flipper to hit a target with a ball (Patent Literature 1).

The game at least partially uses a physics engine, which is software (middleware library) for simulating laws of classical mechanics. In the game, objects that can be moved or that cannot be moved, objects that can be operated or that cannot be operated, etc. are disposed in a virtual game space, and physics computations concerning those objects are performed by using mechanical parameters such as positions, masses, velocities, gravities, and coefficients of restitution. Examples of similar games include games such as squash games and breakout games.

### CITATION LIST

### Patent Literature

### {PTL 1}

Japanese Unexamined Patent Application, Publication No. 2015-024004

### SUMMARY OF INVENTION

### Technical Problem

In a game of the above kind, however, the only operation that the player may perform with the ball is to hit the ball dropping under the influence of a virtual gravity by using the flipper. Therefore, for example, when the ball is present at a position unreachable with the flipper in the virtual game space, the player is not allowed to perform any operation with the ball that might result in compromising the fun of the game.

The present invention has been made in order to solve the problem described above, and it is a chief object thereof to provide a program, etc. that can enhance the fun of a game.

### Solution to Problem

In order to achieve the above object, a program according to an aspect of the present invention is a program for a game executed on an electronic device that accepts player inputs, the program being characterized by causing the electronic device to execute: a screen display step of displaying a game screen including a player object that moves in a game field in which a virtual gravity is set, as well as collidable objects and an operated object that are disposed in the game field; an object control step of causing the operated object to be manipulated on the basis of a player input accepted by the electronic device; and a player-object control step of giving a movement velocity to the player object in a direction toward a target object, which is one of the collidable objects, on the basis of the player input accepted by the electronic device in the case where a predetermined condition is satisfied, and the program being characterized in that the predetermined condition includes a condition that the player object is present in a predetermined area in the game field.

Furthermore, in the present invention, preferably, the electronic device includes a touchscreen and accepts a touch on the touchscreen as a player input, in the operated-object control step, the operated object is manipulated on the basis of the touch detected by the touchscreen, and in the player-object control step, in the case where the predetermined condition is satisfied, the movement velocity is given to the player object on the basis of the touch detected by the touchscreen.

Furthermore, in the present invention, preferably, the operated object is one or more ball hitting objects, and each of the ball hitting objects is configured so that one end thereof on the outer side serves as a center while the other end side thereof is displaced upward and downward, and in the operated-object control step, when a player input is accepted by the electronic device, the other end side of each of the ball hitting objects is displaced to a position on the upper side compared with when a player input is not accepted by the electronic device.

Furthermore, in the present invention, preferably, the predetermined area is an area on the upper side of a predetermined position in the game field.

Furthermore, in the present invention, preferably, in the player-object control step, the velocity of the player object is decelerated before the movement velocity is given to the player object.

Furthermore, in the present invention, preferably, the predetermined condition includes a condition that the velocity of the player object is less than or equal to a predetermined velocity.

Furthermore, in the present invention, preferably, in the player-object control step, the movement velocity is given to the player object further on the basis of a velocity addibility flag being ON, the velocity addibility flag indicating whether or not it is possible to give the movement velocity, and the velocity addibility flag is set to OFF, and the velocity addibility flag is configured so as to be set to ON when at least a predetermined time elapses after being set to OFF.

Furthermore, in the present invention, preferably, the player-object control step includes a step of determining the target object on the basis of the distances of the collidable objects to the player object when the player input is accepted by the electronic device.

Furthermore, in the present invention, preferably, the player-object control step includes a step of determining the target object on the basis of the distances of the collidable objects to the player object when the player input is accepted by the electronic device, as well as priority level information set to the collidable objects.

Furthermore, in the present invention, preferably, the direction in which the movement velocity is given in the player-object control step is a direction closest to a predefined position in the target object above the center point of the target object among directions within a certain height range from the center point of the player object.

Furthermore, in the present invention, preferably, a predetermined parameter is set to the player object, and in the player-object control step, when giving the movement velocity, an additional effect is given to the player object on the basis of the predetermined parameter.

Furthermore, in order to achieve the above object, an electronic device according to an aspect of the present invention is an electronic device that accepts player inputs and that is capable of executing a game, the electronic device being characterized in that: a game screen is displayed, the game screen including a player object that moves in a game field in which a virtual gravity is set, as well as collidable objects and an operated object that are disposed in the game field, the operated object is caused to be manipulated on the basis of a player input accepted by the electronic device, in the case where a predetermined condition is satisfied, a movement velocity is given to the player object in a direction toward a target object, which is one of the collidable objects, on the basis of the player input accepted by the electronic device, and the predetermined condition includes a condition that the player object is present in a predetermined area in the game field.

Furthermore, in order to achieve the above object, a method according to an aspect of the present invention is a method for a game executed on an electronic device that accepts player inputs, the method being characterized by comprising: a screen display step of displaying a game screen including a player object that moves in a game field in which a virtual gravity is set, as well as collidable objects and an operated object that are disposed in the game field; an object control step of causing the operated object to be manipulated on the basis of a player input accepted by the electronic device; and a player-object control step of giving a movement velocity to the player object in a direction toward a target object, which is one of the collidable objects, on the basis of the player input accepted by the electronic device in the case where a predetermined condition is satisfied, and the method being characterized in that the predetermined condition includes a condition that the player object is present in a predetermined area in the game field.

Furthermore, in order to achieve the above object, a system according to an aspect of the present invention is a system for executing a game, the system including a server and an electronic device that accepts player inputs, the system being characterized in that: the electronic device displays a game screen including a player object that moves in a game field in which a virtual gravity is set, as well as collidable objects and an operated object that are disposed in the game field, the server or the electronic device causes the operated object to be manipulated on the basis of a player input accepted by the electronic device, in the case where a predetermined condition is satisfied, the server or the electronic device gives a movement velocity to the player object in a direction toward a target object, which is one of the collidable objects, on the basis of the player input accepted by the electronic device, and the predetermined condition includes a condition that the player object is present in a predetermined area in the game field.

### Advantageous Effects of Invention

The present invention can enhance the fun of a game.

### BRIEF DESCRIPTION OF DRAWINGS

FIG. 1 is a hardware configuration diagram of an electronic device according to an embodiment of the present invention.

FIG. 2 is a functional block diagram of the electronic device according to the embodiment of the present invention.

FIG. 3 shows an example game screen according to the embodiment of the present invention.

FIG. 4 shows an example game screen according to the embodiment of the present invention.

FIG. 5 shows an example game screen according to the embodiment of the present invention.

FIG. 6 is an illustration for explaining an example of the distance between a player object and a collidable object in a game according to the embodiment of the present invention.

FIG. 7 is an illustration for explaining an example of the direction in which a movement velocity is given by a player-object control unit in the game according to the embodiment of the present invention.

FIG. 8 is an illustration for explaining an example of the direction in which a movement velocity is given by the player-object control unit in the game according to the embodiment of the present invention.

FIG. 9 is a flowchart showing information processing according to the embodiment of the present invention.

FIG. 10 shows the overall configuration of a game system according to an embodiment of the present invention.

### DESCRIPTION OF EMBODIMENTS

Now, game systems 1 according to embodiments of the present invention will be described with reference to the drawings. In this description, there are cases where descriptions that are more detailed than are necessary are omitted for convenience of description. For example, there are cases where detailed descriptions of matters that are already well known or repeated descriptions of substantially the same configurations are omitted.

A game system 1 can be realized by a system in which a plurality of electronic devices are connected via a network; alternatively, a game system 1 may be realized by a single electronic device. An embodiment realized by a single electronic device will be described first, and an embodiment realized by a system connected to a network will then be described.

### [Embodiment Realized by an Electronic Device]

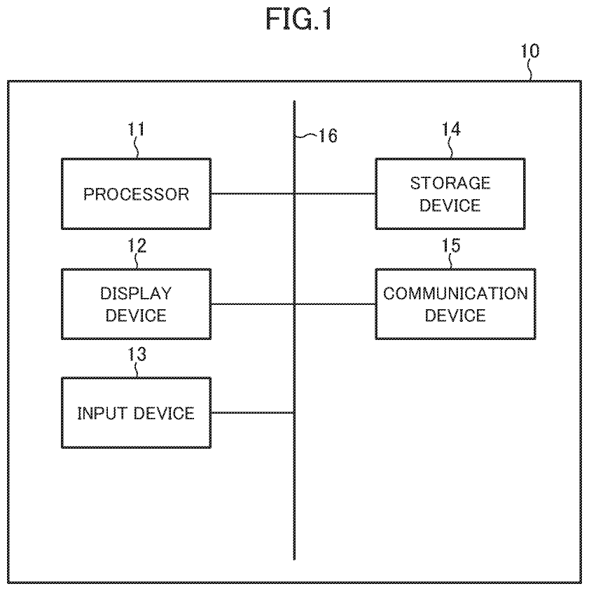

FIG. 1 is a block diagram showing the hardware configuration of an electronic device 10 according to an embodiment of the present invention. The electronic device 10 includes a processor 11, a display device 12, an input device 13, a storage device 14, and a communication device 15. These constituent devices are connected via a bus 16. It is assumed that interfaces are interposed as needed between the bus 16 and the individual constituent devices. In this embodiment, the electronic device 10 is a smartphone. Alternatively, the electronic device 10 may be a terminal such as a computer equipped with a contact-type input device, like a tablet computer or a touchpad, as long as the terminal includes the configuration described above.

The processor 11 controls the overall operation of the electronic device 10. For example, the processor 11 is a CPU. Alternatively, an electronic circuit such as an MPU may be used as the processor 11. The processor 11 executes various kinds of processing by loading programs and data stored in the storage device 14 and executing the programs. In one example, the processor 11 is constituted of a plurality of processors.

The display device (display) 12 displays application screens, etc. to a user (player) of the electronic device 10 under the control of the processor 11. The display device 12 is preferably a liquid crystal display but may be a display utilizing organic EL, a plasma display, or the like.

The input device 13 is a user interface for accepting inputs to the electronic device 10 from the user; for example, the input device 13 is a touchscreen, a touchpad, a keyboard, or a mouse. In this embodiment, since the electronic device 10 is a smartphone, the electronic device 10 includes a touchscreen as the input device 13, and the touchscreen also functions as the display device 12; that is, the display device 12 and the input device 13 have an integrated structure. Alternatively, the display device 12 and the input device 13 may be provided at different positions in separate forms.

The storage device 14 is a storage device included in an ordinary smartphone, including a RAM, which is a volatile memory, and a ROM, which is a non-volatile memory. The storage device 14 may also include an external memory. For example, the storage device 14 stores a game application. The game application includes a game program for executing a game as well as various kinds of data that are referred to when the game program is executed. The game program is activated in response to an operation by the user on the electronic device 10, and is executed on an operating system (OS) preinstalled in the electronic device 10.

In one example, the storage device 14 includes a main storage device and an auxiliary storage device. The main storage device is a volatile storage medium that allows high-speed reading and writing of information, and is used as a storage area and a work area when the processor 11 processes information. The auxiliary storage device stores various kinds of programs and data that are used by the processor 11 when the individual programs are executed. The auxiliary storage device is, for example, a hard disk device; however, the auxiliary storage device may be any type of non-volatile storage or non-volatile memory, which may be of the removable type, that is capable of storing information. The auxiliary storage device stores, for example, an operating system (OS), middleware, application programs, various kinds of data that may be referred to when these programs are executed, etc.

The communication device 15 sends data to and receives data from other computers, such as a server, via a network. For example, the communication device 15 performs wireless communication, such as mobile communication or wireless LAN communication, to connect to the network 2. In one example, a program is downloaded from a server by the communication device 15 and is stored in the storage device 14. Alternatively, the communication device 15 may perform wired communication by using an Ethernet (registered trademark) cable or the like. In the case where data is neither sent to nor received from other computers, the electronic device 10 need not include the communication device 15.

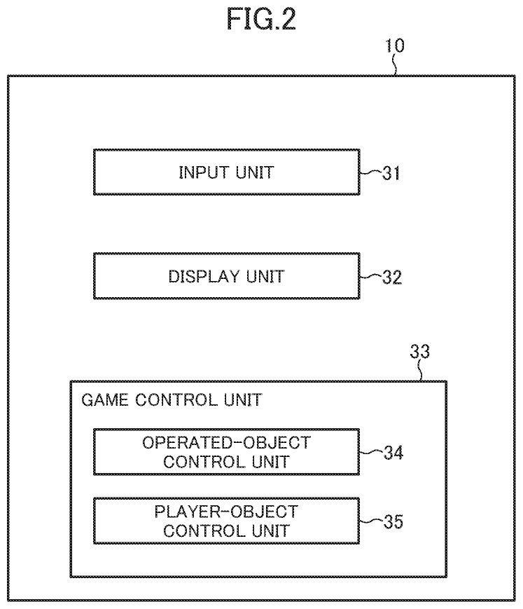

FIG. 2 shows an example functional block diagram of the electronic device 10 according to the embodiment of the present invention. The electronic device 10 includes an input unit 31, a display unit 32, and a game control unit 33. The game control unit 33 includes an operated-object control unit 34 and a player-object control unit 35. In this embodiment, these functions are realized by the processor 11 executing a program. For example, the program that is executed is a game program stored in the storage device 14 or received via the communication device 15. Since various kinds of functions are realized by loading a program, as described above, a portion or the entirety of one part (function) may be provided in another part. Alternatively, these functions may be realized by means of hardware by configuring electronic circuits or the like for realizing the individual functions in part or in entirety.

The input unit 31 is configured by using the input device 13, and accepts inputs to the electronic device 10 from the user. The electronic device 10 accepts user inputs via the input unit 31. In this embodiment, it is possible to use a touch detection function generally provided in a smartphone equipped with a touchscreen.

The display unit 32 displays a game screen including a game field 50 on the display device 12 to display a game screen in accordance with the proceeding of the game or a user operation. The game control unit 33 performs basic control for executing the game in this embodiment.

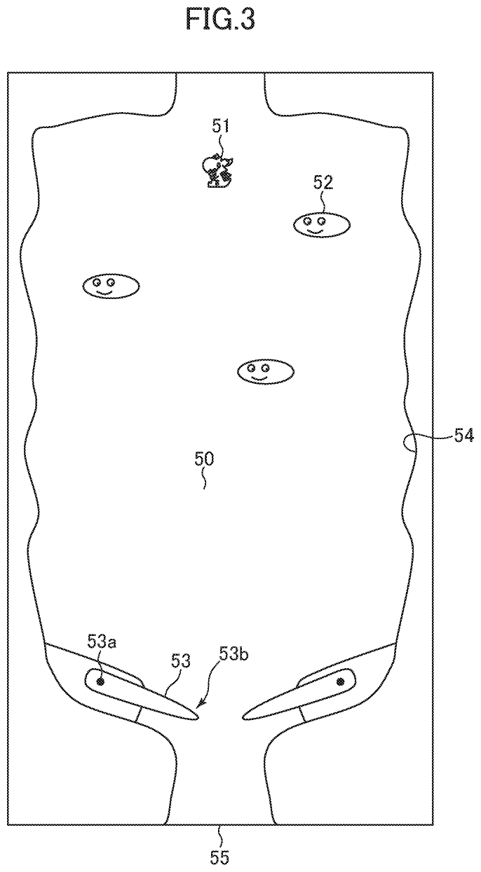

FIG. 3 is an illustration showing an example game screen. The game control unit 33 sets a game field 50 as a virtual space for the proceeding of the game. In the game field 50, a player object 51, collidable objects 52, and an operated object 53 are disposed. The player object 51 is an object that moves in the game field 50, and the collidable objects 52 and the operated object 53 are objects that may collide with the player object 51. The game in this embodiment includes a plurality of game fields 50, and the game control unit 33 can set the individual objects at different positions in the individual game fields 50. FIG. 3 shows an example for a single game field 50.

The game control unit 33 sets virtual gravity in the game field 50. The virtual gravity is a virtual-space reproduction of a phenomenon similar to real-world gravity. The game control unit 33 performs physics computations by using mechanical parameters including the virtual gravity and a coefficient of restitution. It is possible to use a known physics engine for the physics computations. The game control unit 33 sets mechanical parameters, such as the mass, the shape, and a coefficient of restitution, for each of the player object 51, the collidable objects 52, and the operated object 53. These parameters are defined in advance by a game administrator or the like.

The game screen shown in FIG. 3 is a screen displayed over the entire screen of the touchscreen. The game field 50 is configured as a virtual space surrounded by a virtual wall 54. Preferably, the game field 50 is displayed over a large portion of the entire screen, as shown in FIG. 3. On the touchscreen, a position is specified in the form of coordinates by using a coordinate plane defined by a vertical axis direction and a horizontal axis direction. The game control unit 33 identifies a position in the game field 50 by using coordinates. The game control unit 33 defines the lengths of the game screen in the vertical axis direction and the horizontal axis direction to be predetermined lengths, for example, 1920 pixels and 1080 pixels, respectively, and uses the number of the pixels when identifying a distance or position in the game field 50 irrespective of the size or the screen resolution of the touchscreen. It is hereinafter assumed that a “distance” is represented as a length by using one pixel as a unit length unless specifically mentioned otherwise. It is to be noted that, for the identification of a position in the game field 50, without limitation to the above method, the game control unit 33 may use any known method that makes it possible to identify positions in game fields 50 that are displayed in sizes corresponding to the sizes of game screens on touchscreens having different sizes or screen resolutions.

The player object 51 is an object corresponding to a player character, which is an object corresponding to a ball in a pinball game in this embodiment, as shown in FIG. 3. Thus, the player object 51 is an object that can move similarly to a ball. The game control unit 33 controls the action such that the player object 51 moves according to the virtual gravity, and the player object 51 is accelerated in the gravitational direction under the influence of the virtual gravity.

Furthermore, the player character associated with the player object 51 has parameters corresponding to each player character, and the parameters are set in advance by a game administrator or the like. For example, the parameters include a level, an attacking power, hit points, special abilities, etc. It is to be noted that the player object 51 may be an object constituted of a plurality of characters or an object that is just a ball.

The collidable objects 52 are objects that are disposed in the game field 50 and that affect movement of the player object 51. In one example, the game control unit 33 performs collision determination for the player object 51 and the collidable objects 52. It is possible to use a known method for the collision determination. Furthermore, when the player object 51 collides with a collidable object 52, the game control unit 33 performs a physics computation concerning the bouncing action at the time of the collision to determine the velocity of the player object 51.

Furthermore, as shown in FIG. 3, the collidable objects 52 are objects corresponding to enemy characters. Similarly to the player character, each of the enemy characters associated with the collidable objects 52 has parameters corresponding to that enemy character, and the parameters are set in advance by a game administrator or the like. In one example, when the player object 51 collides with a collidable object 52, the game control unit 33 gives an additional effect that is different from an effect based on a physics computation to at least one of the player object 51 and the collidable object 52. For example, when the player object 51 collides with a collidable object 52, the game control unit 33 determines that the player character associated with the player object 51 has inflicted damage on the enemy character associated with the collidable object 52. At this time, the game control unit 33 changes the parameters of the enemy character associated with the collidable object 52, for example, decreases the hit points of the enemy character.

In one example, the collidable objects 52 are objects that are not susceptible to the influence of the virtual gravity. In this case, it becomes possible for the game control unit 33 to continuously dispose the collidable objects 52 at such positions that the fun of the game is enhanced. In one example, the collidable objects 52 (enemy characters) launch attacking objects (not shown). When the player object 51 collides with an attacking object, the game control unit 33 determines that the player character is damaged. At this time, the game control unit 33 changes the parameters of the player character associated with the player object 51, for example, decreases the hit points of the player character.

The collidable objects 52 may be any objects with which the player object 51 may collide. For example, the collidable objects 52 may be objects such as blocks or obstacles disposed in the game field 50 or objects disposed in the game field 50 and constituting characters other than enemies. Furthermore, the collidable objects 52 may be objects that are susceptible to the influence of the virtual gravity.

The operated object 53 is an object that is operated by the user, which is a ball hitting object 53 corresponding to a flipper in a pinball game. As shown in FIG. 3, the operated object 53 is a pair of ball hitting objects 53. The pair of ball hitting objects 53 are each configured to displace the other end side 53b upward and downward with respect to one end 53a on the outer sides. In one example, when the player object 51 collides with the ball hitting objects 53, the game control unit 33 performs a physics computation concerning the bouncing action at the time of the collision to determine the velocity of the player object 51. Preferably, the game control unit 33 corrects the force applied to the player object 51 by the operated object 53, as well as the angle thereof, in consideration of the ease of operation for the user. The operated object 53 may be a single ball hitting object 53 or three or more ball hitting objects 53.

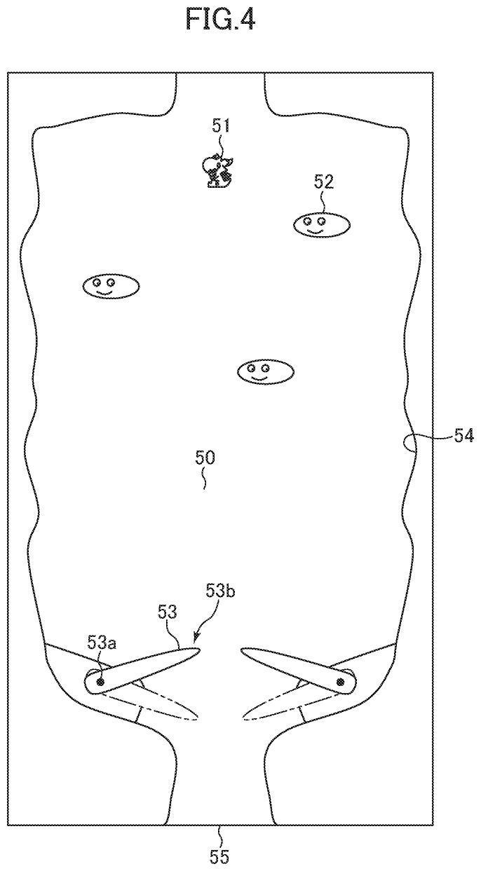

The operated-object control unit 34 causes the operated object 53 to be manipulated on the basis of a touch detected by the touchscreen. Specifically, when a touch is accepted by the touchscreen, the operated-object control unit 34 displaces the other end side 53b of each ball hitting object 53 to a predetermined position on the upper side compared with when a touch is not detected by the touchscreen, as shown in FIG. 4. While a touch is accepted by the touchscreen, the operated-object control unit 34 retains the other end side 53b of each ball hitting object 53 at the predetermined position. The ball hitting objects 53 shown in FIG. 3 are in a state in which a touch is not accepted by the touchscreen. In one example, when a touch is accepted by the touchscreen and the state of the left ball hitting object 53 changes from the state in FIG. 3 to the state in FIG. 4, the operated-object control unit 34 executes control such that the distal end on the other end side 53b becomes displaced by a predetermined distance or clockwise by a predetermined angle about the one end 53b. In one example, in the case where a certain time has elapsed while a touch is being accepted by the touchscreen, the operated-object control unit 34 restores the other end side 53b of each ball hitting object 53 to the original position shown in FIG. 3 and retains the other end side 53b as is.

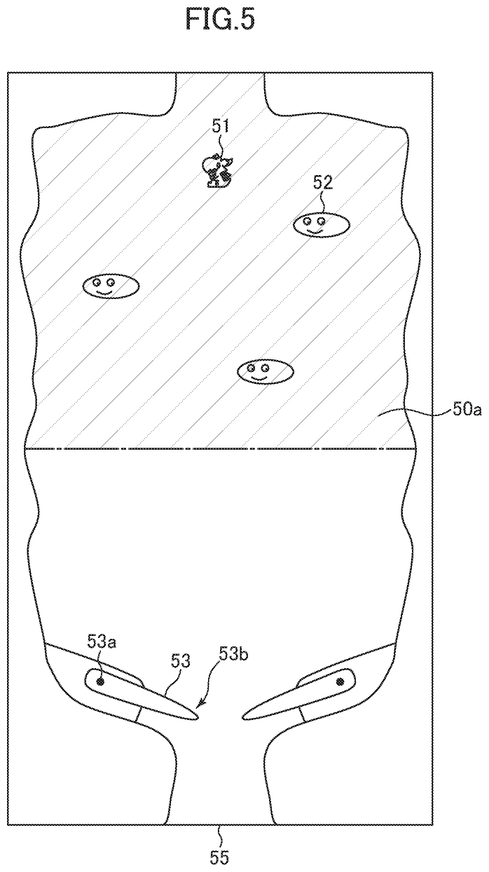

In the case where a predetermined condition is satisfied, the player-object control unit 35, on the basis of a touch detected by the touchscreen, gives a movement velocity to the player object 51 in the direction toward a target object 52, which is one of the collidable objects 52. In one preferred example, the player-object control unit 35 gives a movement velocity to the player object 51 in the direction toward the target object 52 in the case where the predetermined condition is satisfied and a touch is detected by the touchscreen. The predetermined condition is that the player object 51 is located within a predetermined region in the game field 50. For example, the predetermined region is a hatched region 50a on the upper side of a predetermined position in the game field 50, shown in FIG. 5.

The player-object control unit 35 determines a target object on the basis of the distance of the collidable object 52 to the player object 51 when a touch is detected by the touchscreen, and gives a movement velocity in the direction toward the determined target object 52. In one preferred example, in the case where the predetermined condition is satisfied, the player-object control unit 35 calculates the distances between the player object 51 and all the collidable objects 52 disposed in the game field 50. Then, when a touch is detected by the touchscreen, the player-object control unit 35 determines, as a target object 52, the collidable object 52 having the least distance to the player object 51. In the case where the predetermined condition is not satisfied, the player-object control unit 35 does not determine a target object 52. As a result, the player-object control unit 35 does not give a movement velocity to the player object 51. Alternatively, the player-object control unit 35 may be configured to continuously determine a target object 52 regardless of whether or not a touch is detected by the touchscreen in the case where the predetermined condition is satisfied. In this case, the player-object control unit 35 gives a movement velocity to the target object 52 determined at the timing when a touch is detected by the touchscreen.

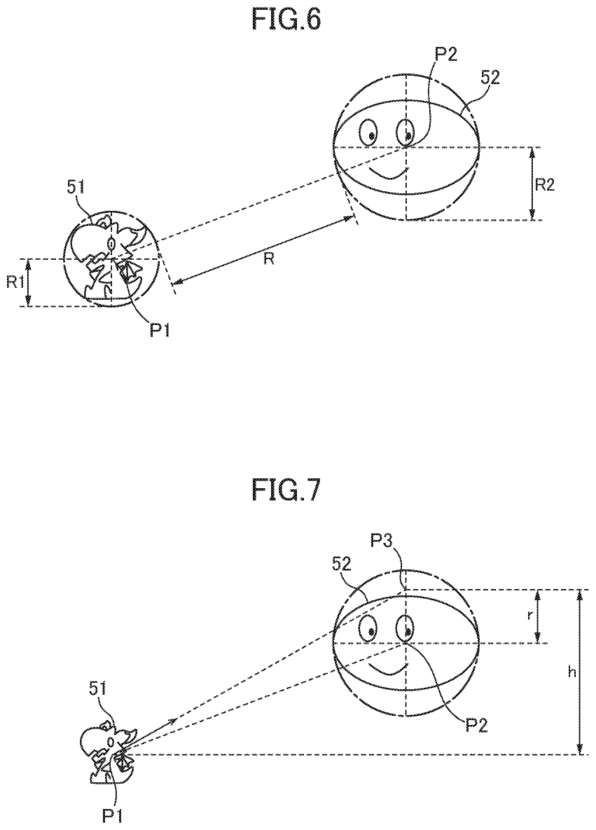

FIG. 6 is an illustration showing an example of the distance between the player object 51 and a collidable object 52. Let P1 signify the center point (center point coordinates) of the player object 51, R1 signify the radius for collision determination therearound, P2 signify the center point of the collidable object 52, and R2 signify the radius for collision determination therearound. Then, the distance R between the player object 51 and the collidable object is expressed by R=|P1−P2|−R1−R2.

The direction in which the player-object control unit 35 gives a movement velocity is the direction closest to a predefined position in the target object 52 above the center point of the target object 52 among directions within a certain height range from the center point of the player object 51.

FIG. 7 is an illustration showing an example of the direction in which the player-object control unit 35 gives a movement velocity. Let P1 signify the center point of the player object 51, R1 signify the radius for collision determination around the player object 51, P2 signify the center point of the collidable object 52, and R2 signify the radius for collision determination around the collidable object 52. Furthermore, let P3 signify a position that is a predefined distance r higher than the center point of the target object 52. For example, the predefined distance r is defined in advance to be 70% of R2. The direction in which the player-object control unit 35 gives a movement velocity is the direction from P1 toward P3, not the direction from P1 toward P2.

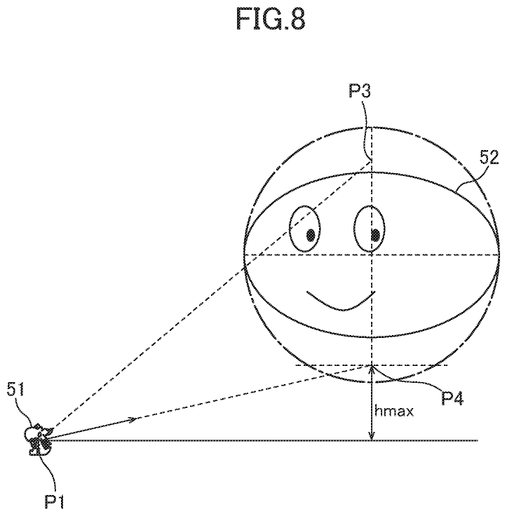

FIG. 8 is an illustration for explaining an example of the direction in which the player-object control unit 35 gives a movement velocity. In the case where the height h of P3 relative to P1 is greater than a predefined value hmax, the direction in which the player-object control unit 35 gives a movement velocity is the direction from P1 toward P4. P4 signifies a position that is the same as P2 along the horizontal axis direction and that is a predefined value hmax higher than the player object 51 along the vertical axis direction. The predefined value hmax is the maximum value of the height component of a movement velocity that can be given by the player-object control unit 35, and is defined to be, for example, 50 pixels.

Once the player-object control unit 35 gives a movement velocity to the player object 51, the player-object control unit 35 does not newly give a movement velocity to the player object 51 unless, for example, the predetermined time elapses, the predetermined condition is satisfied, and a touch is detected by the touchscreen. As described above, once a touch is detected by the touchscreen and the player-object control unit 35 gives a movement velocity to the player object 51, the player-object control unit 35 does not continuously give a movement velocity in response to the detected touch.

The magnitude of the movement velocity that is given by the player-object control unit 35 is constant. The velocity of the player object 51 to which a movement velocity has been given becomes a vector amount obtained by combining the movement velocity (vector) and the velocity (vector) before the movement velocity is given. Therefore, there are cases where the player-object control unit 35 gives a movement velocity in the direction toward the target object 52 but the player object 51 does not collide with the target object 52. For example, in the case where the distance between the player object 51 and the target object 52 is relatively large, the player object 51 drops under the influence of the virtual gravity before reaching the target object 52 at the movement velocity given by the player-object control unit 35.

The player-object control unit 35 decelerates the velocity of the player object 51 before giving a movement velocity to the player object 51. The player-object control unit 35 performs this deceleration by multiplying the velocity of the player object 51 by a predefined constant.

The predetermined condition further includes a condition that the velocity of the player object 51 is less than or equal to a predetermined velocity. In one example, the predetermined condition further includes a condition that the elevating velocity of the player object 51 is less than or equal to a predetermined value.

The player-object control unit 35 sets a velocity addibility flag indicating whether or not it is possible to give a movement velocity to the player object 51. For example, the player-object control unit 35 sets the velocity addibility flag by setting “0” when in the OFF state and “1” when in the ON state in an area for storing the velocity addibility flag in the storage device 14. The player-object control unit 35 gives a movement velocity to the player object 51 in the direction toward the target object 52 further on the basis of the velocity addibility flag being ON. That is, the player-object control unit 35 does not give a movement velocity unless the velocity addibility flag is in the ON state. The predetermined condition may include a condition that the velocity addibility flag is in the ON state. For example, the velocity addibility flag may be set to be “1” when in the OFF state and “0” when in the ON state.

The velocity addibility flag is set to the ON state in the initial state. When a movement velocity is given to the player object 51, the player-object control unit 35 sets the velocity addibility flag to the OFF state. The game control unit 33 sets the velocity addibility flag to the ON state when a predetermined time has elapsed. In one example, the game control unit 33 is configured to set the velocity addibility flag to the ON state in the case where a predetermined event has occurred in the game field 50. The velocity addibility flag includes the concept of a velocity unaddibility flag. In the case of a velocity unaddibility flag, the player-object control unit 35 gives a movement velocity to the player object 51 in the direction toward the target object 52 further on the basis of the velocity unaddibility flag being OFF.

Furthermore, it is possible to use a gauge instead of a flag as the velocity addibility flag, and the player-object control unit 35 may use gauge values correspondingly to the ON state and the OFF state of the velocity addibility flag. The time elapsed is calculated, for example, on the basis of the frame rate and the number of frames elapsed.

Next, an example of the game according to this embodiment will be briefly described. The game control unit 33 lets the user select a player character as the player object 51 from a plurality of player characters. For the player character, parameters such as a level, an attacking power, hit points, and special abilities are set. The game control unit 33 causes a game screen including a game field 50 to be displayed on the touchscreen. In the game field 50, at least when the game is started, the player object 51 corresponding to the player character, collidable objects corresponding to enemy characters, and a pair of ball hitting objects 53 are disposed. The player object 51 is moved in the game field 50 according to a virtual gravity, like a ball in a pinball game. The ball hitting objects 53 are disposed in a bottom portion in the gravitational direction so that the dropping player object 51 can be hit by causing the ball hitting objects 53 to be manipulated up and down about the one ends 53a in accordance with user operations.

When the player object 51 corresponding to the player character collides with a collidable object corresponding to an enemy character, the game control unit 33 determines that the player character has attacked the enemy character and thus decreases the hit points of the enemy character. Meanwhile, when the player object 51 corresponding to the player character collides with an attacking object launched by a collidable object corresponding to an enemy character, the game control unit 33 determines that the player character has been attacked and thus decreases the hit points of the player character.

Furthermore, in the game field 50, a gap through which the player object 51 can be passed is formed between the pair of ball hitting objects 53, and a hole 55 is formed further downward in the gravitational direction. When the player object 51 drops into the hole 55, the game control unit 33 gives a negative effect to the user, such as decreasing the hit points of the player character. When the hit points of the enemy characters in the game field 50 become zero before the hit points of the player character become zero, the game control unit 33 determines that the user has cleared the game field 50 and presents a next game field 50 to the user.

As described above, one of the objectives of the game in this embodiment is to hit the collidable objects 52 corresponding to the enemy characters with the player object 51 while keeping the player object 51 from hitting attacking objects or dropping into the hole 55.

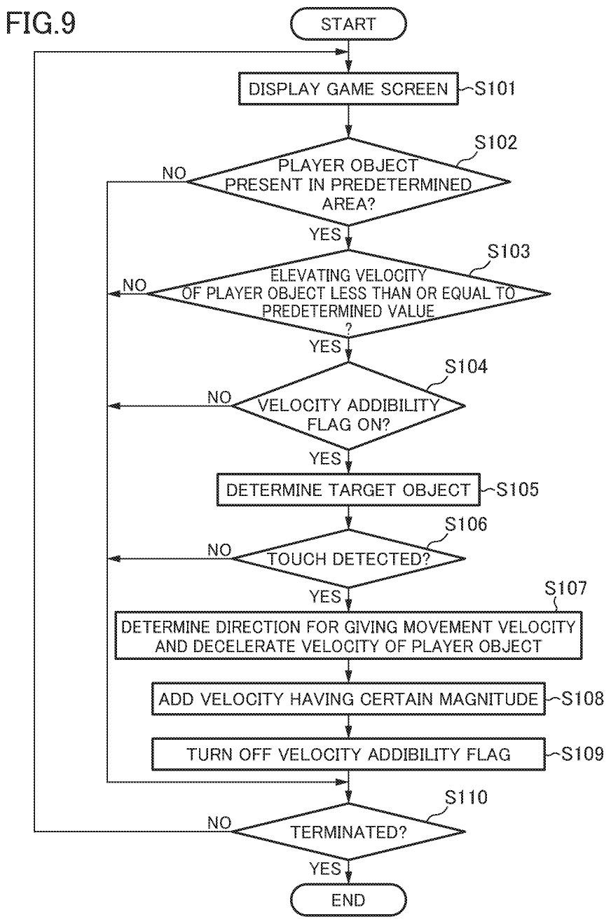

Next, information processing concerning movement velocity control for the player object 51 in the electronic device 10 (game system 1) according to the embodiment of the present invention will be described with reference to a flowchart shown in FIG. 9. In this embodiment, a smartphone is used as the electronic device 10. Generally, a frame rate such as 30 fps or 60 fps is set in a smartphone. Preferably, the electronic device 10 executes processing at certain time intervals in accordance with the frame rate. The flowchart is executed, for example, as a portion of the main loop of the game program.

First, the electronic device 10 displays a game screen (step 101).

In step 102, the electronic device 10 determines whether or not the player object 51 is present in a predetermined area. In the case where the player object 51 is present in the predetermined area, the processing proceeds to step 103. In the case where the player object 51 is not present in the predetermined area, the processing proceeds to step 110, and returns to step 101 unless the game is terminated.

In step 103, the electronic device 10 determines whether or not the elevating velocity of the player object 51 is less than or equal to a predetermined value. In the case where the elevating velocity of the player object 51 is less than or equal to the predetermined value, the processing proceeds to step 104. In the case where the elevating velocity is greater than the predetermined value, the processing proceeds to step 110.

In step 104, the electronic device 10 determines whether or not the velocity addibility flag is ON. In the case where the velocity addibility flag is ON, the processing proceeds to step 105. In the case where the flag is OFF, the processing proceeds to step 110.

In step 105, the electronic device 10 determines, as a target object 52, the collidable object 52 having the least distance to the player object 51. At this time, the electronic device 10 calculates the distances between the player object 51 and all the collidable objects 52 disposed in the game field 50 and determines the target object 52 by using the results of the calculation. Alternatively, the electronic device 10 may perform processing for calculating the distances separately from the processing being described.

Next, in step 106, the electronic device 10 determines whether a touch is detected by the touchscreen. In the case where a touch is detected, the processing proceeds to step 107. In the case where a touch is not detected, the processing proceeds to step 110.

In step 107, the electronic device 10 determines the direction in which a movement velocity toward the target object 52 determined in step 105 is to be given. The direction in which a movement velocity is to be given is the direction from P1 toward P3 in the case where the height h of P3 relative to P1 shown in FIGS. 7 and 8 is less than the predefined value hmax and is the direction from P1 toward P4 in the case where the height h is greater than the predefined value hmax. Furthermore, in step 107, the electronic device 10 decelerates the velocity of the player object 51 before giving a movement velocity.

In step 108, the electronic device 10 gives a velocity having a certain predefined magnitude and having the direction determined in step 107 to the player object 51.

In step 109, the electronic device 10 sets the velocity addibility flag to the OFF state, and the processing returns to step 101 unless the game is terminated (step 110). The electronic device 10 may explicitly indicate that a movement velocity is not given to the player object 51, for example, by adding an animation showing the player character sweating, in the case where the processing proceeds from step 102, 103, or 104 to step 109.

It is to be noted that the processing in the individual steps in the flowchart is merely an example, and the order of processing of the individual steps may be changed or other processing may be executed in addition to or instead of the processing in the individual steps as long as the same results are obtained. For example, it is possible to change the order of processing of steps 102 to 104, and it is possible to change the order of processing of steps 105 and 106.

In one example, step 101 is a screen displaying step that is executed by the display unit 32. In one example, steps 105 to 109 are player-object control steps that are executed by the player-object control unit 35. In one example, when a touch is detected by the touchscreen in step 106, the operated-object control unit 34 executes an operated-object control step (not shown) of causing the operated object 53 to be manipulated on the basis of the touch detected by the touchscreen.

Next, the operations and advantages of the electronic device 10 according to the embodiment of the present invention will be described. In this embodiment, when a touch is accepted by the touchscreen, the game control unit 33 moves (displaces) the ball hitting objects 53, and also gives a movement velocity to the player object 51 in the direction toward the target object 52 in the case where a predetermined condition is satisfied. The predetermined condition is a condition that the player object 51 is present in an area 50a above a predetermined position in the game field 50.

Here, in the game in this embodiment, the player object 51 moves in the game field 50 according to a virtual gravity, like a ball in a pinball game. In existing games, it has been possible to change the movement direction of the player object by a user operation only by causing the ball hitting objects to be manipulated so as to hit the player object by the user operation. Therefore, it has not been possible for the user to actively perform a user operation when the player object is present in the area 50a. With the configuration according to this embodiment, it becomes possible to give a movement velocity to the player object 51 in the direction toward the target object 52 in the case where the player object 51 is present in the area 50a, which makes it possible to enhance the fun of the game.

The fun of the game can be enhanced similarly if the area specified in the predetermined condition is an area remote from the ball hitting objects 53 in the game field 50, as well as the area 50a.

Furthermore, in this embodiment, the magnitude of the movement velocity given by the player-object control unit 35 is constant. Therefore, there are cases where the player-object control unit 35 gives a movement velocity in the direction toward the target object 52 but the player object 51 does not collide with the target object 52. With this configuration, depending on the movement velocity given by the player-object control unit 35, it becomes possible to reliably prevent the player object 51 from colliding with the target object 52. Accordingly, for example, the user has to perform a touch while considering the timing of collision with the target object 52 in addition to the timing for determining the target object 52, it becomes possible to enhance the fun of the game.

Furthermore, in this embodiment, the player-object control unit 35 decelerates the velocity of the player object 51 before giving a movement velocity to the player object 51. With this configuration, it becomes possible to enhance the effect of the movement velocity given by the player-object control unit 35 in the case where the velocity of the player object 51 before the movement velocity is given is high.

Furthermore, in this embodiment, the predetermined condition further includes a condition that the elevating velocity of the player object 51 is less than or equal to a predetermined value. With this configuration, in this embodiment, for example, it is possible to prevent the fun of the game from being compromised as a result of giving an excessive movement velocity to the player object 51 to which an elevating velocity has been given as a result of being hit by the ball hitting objects 53.

In this embodiment, the player-object control unit 35 gives a movement velocity to the player object 51 in the direction toward the target object 52 further on the basis of the velocity addibility flag being ON. With this configuration, in this embodiment, it becomes possible to prevent the possibility that the player-object control unit 35 might continuously keep on giving a movement velocity in the case where the player object 51 is present in an area satisfying the predetermined condition, thereby preventing the fun of the game from being compromised.

Furthermore, in this embodiment, when a touch is detected by the touchscreen, the player-object control unit 35 determines, as a target object 52, the collidable object 52 having the least distance to the player object 51. With this configuration, in this embodiment, it becomes even easier to predict the direction in which a movement velocity is to be given, which makes it possible to provide ease of operation so that the user will be able to give a movement velocity in the intended direction.

Furthermore, in this embodiment, the direction in which a movement velocity is given by the player-object control unit 35 is the direction closest to a predefined position in the target object 52 above the center point of the target object 52 among directions within a certain height range from the center point of the player object 51. Specifically, the direction in which a movement velocity is given is the direction from P1 toward P3 in the case where the height h of P3 relative to P1 shown in FIGS. 7 and 8 is less than the predefined value hmax and is the direction from P1 toward P4 in the case where the height h is greater than the predefined value hmax. With this configuration, it becomes possible for the player-object control unit 35 to give a movement velocity in the direction toward the target object 52 while considering the influence of the virtual gravity. At the same time, it becomes possible to prevent the height component of the movement velocity given by the player-object control unit 35 from exceeding the predefined value hmax, thereby preventing the player object 51 from being elevated and moved against the intent of the user. For example, in the case shown in FIG. 8, compared with the case where a movement velocity is given in the direction from P1 toward P3 or the case where a movement velocity is given in the direction from P1 toward P4, the horizontal axis component of the movement velocity that is given becomes smaller, and thus there is a greater influence of the virtual gravity. In this embodiment, it becomes possible to prevent such a phenomenon.

The operations and advantages described above also apply to other embodiments and other examples unless specifically mentioned otherwise.

### [Embodiment Realized by a System]

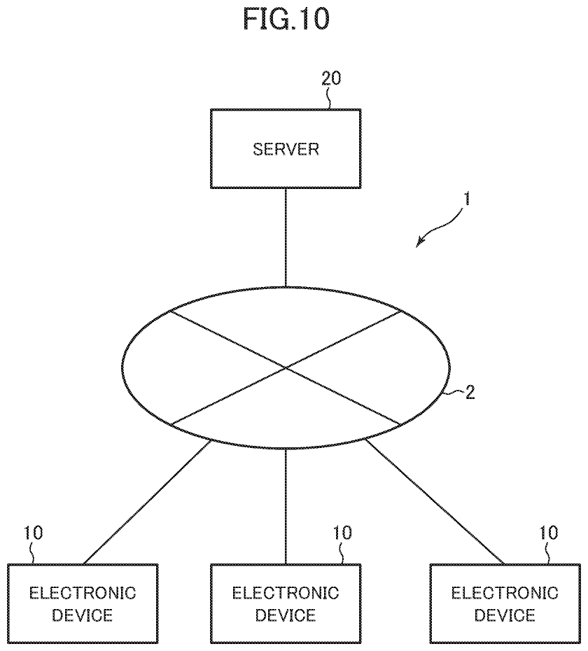

FIG. 10 shows an example of the overall configuration of a game system 1 according to an embodiment of the present invention. As shown in FIG. 10, the game system 1 includes a plurality of electronic devices 10 and a server 20, and the electronic devices 10 and the server 20 are connected to a network 2, such as the Internet, so as to be able to communicate with each other. Although it is assumed that the game system 1 in this embodiment is a server-client system, the game system 1 may be configured as a system not including the server 20, like a P to P system.

The electronic devices 10 have the same hardware configuration as what is shown in FIG. 1, and are smartphones also in this embodiment. The server 20 is a server device that provides a game that can be executed on the electronic devices 10, and is constituted of one or more computers.

The server 20 stores various programs, such as a control program for controlling the proceeding of an online game, and various kinds of data that are used in the game.

In one example, the server 20 is configured to be able to provide the electronic devices 10 with a game application that can be executed on the electronic devices 10. When an electronic device 10 executes a downloaded game application, the electronic device sends data to and receives data from the server 20 regularly or as needed, thereby proceeding with the game. For example, the server 20 stores various kinds of setting information, history information, etc. needed for the game executed on the electronic device 10. In this case, the electronic device 10 has the function of the game control unit 33.

In one example, the server 20 is a web server and provides the electronic devices 10 with a game service. The electronic devices 10 obtain HTML data for displaying a webpage from the server 20 and parse the obtained HTML data to display the webpage. In this case, the server 20 that communicates with the electronic devices 10 has the function of the game control unit 33.

In one example, the game system 1 provides a game that can be played by a plurality of users in a single game field 50. For example, collidable objects 52 may be objects operated by other users.

Another embodiment of the present invention may be a program for realizing the functions or the information processing shown in the flowchart in the above-described embodiment of the present invention, or a computer-readable storage medium storing the program. Furthermore, another embodiment of the present invention may be a method for realizing the functions or the information processing shown in the flowchart in the above-described embodiment of the present invention. Furthermore, another embodiment of the present invention may be a server that is capable of providing a computer with a program for realizing the functions or the information processing shown in the flowchart in the above-described embodiment of the present invention. Furthermore, another embodiment of the present invention may be a virtual machine for realizing the functions or the information processing shown in the flowchart in the above-described embodiment of the present invention.

Now, modifications of the embodiments of the present invention will be described. The modifications described below can be combined as appropriate and applied to any embodiment of the present invention as long as no inconsistency arises.

In one modification, the input device 13 of the electronic device 10 is a button on a controller, a keyboard, a mouse, or the like connected to the electronic device 10, and the electronic device 10 is not equipped with a touchscreen. In this case, the input unit 31 obtains operation information accepted by the input device 13 in accordance with a user operation. The presence or absence of an input from the input device 13 corresponds to whether or not a touch is detected by the touchscreen in the case where the electronic device 10 is equipped with a touchscreen.

In one modification, priority level information is set for collidable objects. The priority level information may be one of the parameters corresponding to an enemy character. In this case, the player-object control unit 35 determines a target object 52 on the basis of the distances of the collidable objects to the player object 51 when a touch is detected by the touchscreen as well as the priority level information set for the collidable objects 52, and gives a movement velocity in the direction toward the determined target object 52. For example, the player-object control unit 35 determines, as a target object 52, the collidable object 52 having the smallest product of the distance of the collidable object 52 to the player object 51 when a touch is detected by the touchscreen and the value of the priority level information set to the collidable object 52.

In one modification, the player-object control unit 35 varies the magnitude of the movement velocity that is given to the player object 51 corresponding to the player character in accordance with the parameters of the player character. This makes it possible to enhance the fun of the game. The player-object control unit 35 may also be configured to vary the magnitude of the movement velocity that is given to the player object 51 in accordance with the proceeding of the game.

In one modification, the player-object control unit 35 does not decelerate the velocity of the player object 51 before giving a movement velocity to the player object 51. In one modification, the predetermined condition does not include the condition that the velocity of the player object 51 is less than or equal to a predetermined velocity.

In one modification, the game control unit 33 does not perform collision determination for the player object 51 and a collidable object 52 for a predetermined period in accordance with the parameters owned by the player character or the enemy character associated with the player object 51 or the collidable object 52. At this time, the player object 51 penetrates through the collidable object 52.

In one modification, when the player-object control unit 35 gives a movement velocity to the player object 51, the game control unit 33 gives an additional effect on the basis of the parameters set for the player object 51. For example, the parameters set for the player object 51 are the parameters owned by the player character associated with the player object 51. As an additional effect, for example, the player-object control unit 35 can set the parameters of the player character so that the game control unit 33 will not perform collision determination for the player object 51 and the collidable objects 52 for a predetermined period since a movement velocity is given.

In one modification, in the case where the player object 51 is present in the area 50a, the game control unit 33 counts the number of times that the player object 51 collided with the collidable objects 52 and stores information corresponding to the number of collisions in the storage device 14. When the player object moves out of the area 50a and collides with the ball hitting objects 53, the game control unit 33 gives a predetermined special effect, which is different from the effect based on a physics computation, on the basis of the number of collisions. The predetermined special effect may be an increase in the collision range in which the player object 51 may collide with the collidable objects 52, a penetrating effect, or the like. Alternatively, the predetermined special effect may be an increase in the attacking power, an increase in a special ability, or the like of the player character associated with the player object 51. Preferably, the game control unit 33 causes the predetermined special effect to be generated at the time of collision between the player object 51 and the ball hitting objects 53 and causes the predetermined special effect to disappear after the elapse of a predefined time. After giving the predetermined special effect, the game control unit 33 resets the information corresponding to the number of collisions by restoring the information to an initial value (e.g., zero). With this configuration, it becomes possible for the user to increase the count of the number of collisions to attain the predetermined special effect by actively giving a movement velocity to the player object 51, which makes it possible to enhance the fun of the game. Alternatively, the game control unit 33 may reset the information corresponding to the number of collisions in the case where the player object 51 has dropped into the hole 55 or in the case where a predetermined event has occurred in the game field 50.

In one modification, the game control unit 33 does not set a virtual gravity in the game field 50, and performs physics computations using mechanical parameters including a coefficient of restitution other than virtual gravity. For example, in the case where only a coefficient of restitution 1 is applied as a mechanical parameter, it becomes possible for the game control unit 33 to move the player object 51 similarly to a ball in a breakout game.

The processing or operation described above may be modified freely as long as no inconsistency arises in the processing or operation, such as an inconsistency that a certain step utilizes data that may not yet be available in that step. Furthermore, the examples described above are examples for explaining the present invention, and the present invention is not limited to those examples. The present invention can be embodied in various forms as long as there is no departure from the gist thereof.

### REFERENCE SIGNS LIST

1 Game system
2 Network
10 Electronic device
11 Processor
12 Display device
13 Input device
14 Storage device
15 Communication device
20 Server
31 Input unit
32 Display unit
33 Game control unit
34 Operated-object control unit
Player-object control unit
51 Player object
52 Collidable object
53 Operated object (ball hitting objects)
53a One end
54 Wall
55 Hole

1. A non-transitory computer readable medium storing a program for a game executed on an electronic device that accepts player inputs, the program causing the electronic device to execute:
a screen display step of displaying a game screen including a player object that moves in a game field in which a virtual gravity is set, as well as collidable objects and an operated object that are disposed in the game field;
an object control step of causing the operated object to be manipulated on the basis of a player input accepted by the electronic device; and
a player-object control step of giving a movement velocity to the player object in a direction toward a target object, which is one of the collidable objects, on the basis of the player input accepted by the electronic device in the case where a predetermined condition is satisfied,
wherein the predetermined condition includes a condition that the player object is present in a predetermined area in the game field.

2. The non-transitory computer readable medium according to claim 1,
wherein the electronic device includes a touchscreen and accepts a touch on the touchscreen as a player input,
wherein, in the operated-object control step, the operated object is manipulated on the basis of the touch detected by the touchscreen, and
wherein, in the player-object control step, in the case where the predetermined condition is satisfied, the movement velocity is given to the player object on the basis of the touch detected by the touchscreen.

3. The non-transitory computer readable medium according to claim 1,
wherein the operated object is one or more ball hitting objects, and each of the ball hitting objects is configured so that one end thereof on the outer side serves as a center while the other end side thereof is displaced upward and downward, and
wherein, in the operated-object control step,
when a player input is accepted by the electronic device, the other end side of each of the ball hitting objects is displaced to a position on the upper side compared with when a player input is not accepted by the electronic device.

4. The non-transitory computer readable medium according to claim 1, wherein the predetermined area is an area on the upper side of a predetermined position in the game field.

5. The non-transitory computer readable medium according to claim 1,
wherein, in the player-object control step,
the velocity of the player object is decelerated before the movement velocity is given to the player object.

6. The non-transitory computer readable medium according to claim 1, wherein the predetermined condition includes a condition that the velocity of the player object is less than or equal to a predetermined velocity.

7. The non-transitory computer readable medium according to claim 1,
wherein, in the player-object control step,
the movement velocity is given to the player object further on the basis of a velocity addibility flag being ON, the velocity addibility flag indicating whether or not it is possible to give the movement velocity, and the velocity addibility flag is set to OFF, and
wherein the velocity addibility flag is configured so as to be set to ON when at least a predetermined time elapses after being set to OFF.

8. The non-transitory computer readable medium according to claim 1,
wherein the player-object control step includes:
a step of determining the target object on the basis of the distances of the collidable objects to the player object when the player input is accepted by the electronic device.

9. The non-transitory computer readable medium according to claim 1,
wherein the player-object control step includes:
a step of determining the target object on the basis of the distances of the collidable objects to the player object when the player input is accepted by the electronic device, as well as priority level information set to the collidable objects.

10. The non-transitory computer readable medium according to claim 1, wherein the direction in which the movement velocity is given in the player-object control step is a direction closest to a predefined position in the target object above the center point of the target object among directions within a certain height range from the center point of the player object.

11. The non-transitory computer readable medium according to claim 1,
wherein a predetermined parameter is set for the player object, and
wherein, in the player-object control step, when giving the movement velocity, an additional effect is given to the player object on the basis of the predetermined parameter.

12. An electronic device that accepts player inputs and that is capable of executing a game,
wherein a game screen is displayed, the game screen including a player object that moves in a game field in which a virtual gravity is set, as well as collidable objects and an operated object that are disposed in the game field,
wherein the operated object is caused to be manipulated on the basis of a player input accepted by the electronic device,
wherein, in the case where a predetermined condition is satisfied, a movement velocity is given to the player object in a direction toward a target object, which is one of the collidable objects, on the basis of the player input accepted by the electronic device, and
wherein the predetermined condition includes a condition that the player object is present in a predetermined area in the game field.

13. A method for a game executed on an electronic device that accepts player inputs, the method comprising:
a screen display step of displaying a game screen including a player object that moves in a game field in which a virtual gravity is set, as well as collidable objects and an operated object that are disposed in the game field;
an object control step of causing the operated object to be manipulated on the basis of a player input accepted by the electronic device; and
a player-object control step of giving a movement velocity to the player object in a direction toward a target object, which is one of the collidable objects, on the basis of the player input accepted by the electronic device in the case where a predetermined condition is satisfied,
wherein the predetermined condition includes a condition that the player object is present in a predetermined area in the game field.

14. A system for executing a game, the system including a server and an electronic device that accepts player inputs,
wherein the electronic device displays a game screen including a player object that moves in a game field in which a virtual gravity is set, as well as collidable objects and an operated object that are disposed in the game field,
wherein the server or the electronic device causes the operated object to be manipulated on the basis of a player input accepted by the electronic device,
wherein, in the case where a predetermined condition is satisfied, the server or the electronic device gives a movement velocity to the player object in a direction toward a target object, which is one of the collidable objects, on the basis of the player input accepted by the electronic device, and
wherein the predetermined condition includes a condition that the player object is present in a predetermined area in the game field.
